(19) United States
(12) Patent Application Publication
(10) Pub. No.: US 2026/0250206 A1
(43) Pub. Date: Aug. 27, 2026

(54) COMPOSITION FOR MANUFACTURING SILICON NITRIDE SUBSTRATE AND SILICON NITRIDE SUBSTRATE MANUFACTURED THEREBY

(71) Applicant: AMOSENSE CO., LTD., Cheonan-si, Chungcheongnam-do (KR)

(72) Inventors: Young-Jun AN, Cheonan-si, Chungcheongnam-do (KR); Gil-Sun LEE, Cheonan-si, Chungcheongnam-do (KR); Jung-Kyun SHIN, Cheonan-si, Chungcheongnam-do (KR); Hun CHEONG, Cheonan-si, Chungcheongnam-do (KR); Chang-Woo OH, Cheonan-si, Chungcheongnam-do (KR); Gug Ho YOON, Cheonan-si, Chungcheongnam-do (KR)

(73) Assignee: AMOSENSE CO., LTD., Cheonan-si, Chungcheongnam-do (KR)

(21) Appl. No.: 19/159,563

(22) PCT Filed: Feb. 22, 2024
(86) PCT No.: PCT/KR2024/002324

§ 371 Date: Aug. 25, 2025

(30) Foreign Application Priority Data
Feb. 24, 2023 (KR) 10-2023-0025261
Feb. 24, 2023 (KR) 10-2023-0025262

(51) Int. Cl. C04B 35/591; C04B 35/63

(52) U.S. Cl. CPC C04B 35/591; C04B 35/6303; C04B 2235/3856; C04B 2235/3873; C04B 2235/5436; C04B 2235/5445; C04B 2235/5472

(57) ABSTRACT

Provided is a composition for manufacturing a silicon nitride substrate. According to an embodiment of the present invention, the composition for manufacturing a silicon nitride substrate comprises a mixed powder including a silicon-based powder and a nitride-based sintering aid, wherein the mixed powder has a particle distribution coefficient of variation (CV value) of 65-86%. According to the present invention, the sintered body is compact and has excellent thermal conductivity, and uniform physical properties can be exhibited whilst also having excellent mechanical strength such as bending strength or abrasion resistance.

### CROSS REFERENCE TO RELATED APPLICATIONS

This application is the National Phase Entry of International Application No. PCT/KR2024/002324, filed on Feb. 22, 2024, which is based upon and claims priority to Korean Patent Application Nos. 10-2023-0025262, filed on Feb. 24, 2023; and 10-2023-0025261, filed on Feb. 24, 2023, the entire contents of which are incorporated herein by reference.

### TECHNICAL FIELD

The present invention relates to a composition for manufacturing a silicon nitride substrate, and more specifically to a composition for manufacturing a silicon nitride substrate and a silicon nitride substrate manufactured thereby.

### BACKGROUND

Silicon nitride has been actively researched for industrial use because it has excellent mechanical properties, oxidation resistance and chemical stability. However, it has a disadvantage of high manufacturing cost compared to other materials, such as metals, due to expensive raw material powder and high sintering temperature. In addition, surface processing is additionally required to increase the dimensional accuracy of manufactured parts due to the relatively high sintering shrinkage after sintering, and in this case, expensive equipment such as diamond grinding agents are required for the processing process due to the high strength, hardness and fracture toughness of silicon nitride, which requires additional manufacturing costs. This high manufacturing cost, along with low reliability compared to metals, has been the most important factor restraining the industrial use of silicon nitride parts.

The reaction sintering method has been noted as a process for improving the shortcomings of silicon nitride. The reaction sintering method of silicon nitride uses high-purity silicon powder as a starting material.

That is, after silicon is shaped into a desired shape, it is slowly heated in a nitrogen atmosphere at 1,350 to 1,450° C. for several hours, and silicon reacts with nitrogen to form silicon nitride.

As nitrogen is added to the silicon structure during the nitriding process, the volume increases along with the mass, but there is no significant difference in the size of the molded body, and this is because the volume expansion proceeds in a direction of filling the pores of the molded body. As a result, the relative density of the molded body increases from about 60% to over 70%, and the sintering shrinkage rate also decreases.

However, silicon nitride molded bodies manufactured by the reaction sintering method generally had a problem of requiring a higher sintering temperature than those manufactured by a process using conventional fine silicon nitride raw material powder, and the mechanical properties of the manufactured products were also poor. Moreover, conventional silicon nitride molded bodies had a problem of not being able to simultaneously exhibit the effects of excellent density and thermal conductivity, excellent mechanical strength such as bending strength and wear resistance, and uniform properties.

Accordingly, there is an urgent need for research on the manufacture of a silicon nitride substrate that has excellent density and thermal conductivity, excellent mechanical strength such as bending strength and wear resistance, and can exhibit uniform physical properties.

### SUMMARY OF THE INVENTION

The present invention has been devised to solve the above-mentioned problems of the related art, and an object of the present invention is to provide a composition for manufacturing a silicon nitride substrate having excellent sintered body density and thermal conductivity, excellent mechanical strength such as bending strength and wear resistance, and capable of exhibiting uniform physical properties, and a silicon nitride substrate manufactured thereby.

In order to solve the above-described problems, the present invention provides a composition for manufacturing a silicon nitride substrate, including a mixed powder including a silicon-based powder and a nitride-based sintering aid, wherein the mixed powder has a particle distribution coefficient of variation (CV value) of 60 to 86%.

According to an embodiment of the present invention, the mixed powder may have an average particle diameter of 0.5 to 4 μm.

In addition, the mixed powder may have a ratio of a particle size distribution D10 (μm) and a particle size distribution D50 (μm) of 1:1.8 to 18.5.

In addition, the mixed powder may have a particle size distribution D10 of 0.15 to 0.55 μm, a particle size distribution D50 of 1 to 2.7 μm, and a particle size distribution D90 of 3.8 to 6.2 μm.

In addition, the silicon-based powder may include a first silicon-based powder and a second silicon-based powder having a smaller average particle diameter than the first silicon-based powder.

In addition, a content of the first silicon-based powder may be greater than a content of the second silicon-based powder.

In addition, a particle distribution coefficient of variation (CV value) of the second silicon-based powder may be greater than a particle distribution coefficient of variation (CV value) of the first silicon-based powder.

In addition, the first silicon-based powder may have an average particle diameter of 4.1 to 6.6 μm, and the second silicon-based powder may have an average particle diameter of 1.1 to 3.7 μm.

In addition, the silicon-based powder may include the first silicon-based powder and the second silicon-based powder in a weight ratio of 1:0.4 to 0.7.

In addition, the first silicon-based powder may have a particle size distribution D10 of 2.2 to 3.8 μm, a particle size distribution D50 of 4.1 to 6.5 μm and a particle size distribution D90 of 6.7 to 9.1 μm, and the second silicon-based powder may have a particle size distribution D10 of 0.4 to 0.95 μm, a particle size distribution D50 of 1.1 to 2.8 μm and a particle size distribution D90 of 3 to 6.6 μm.

In addition, the first silicon-based powder may have a particle distribution coefficient of variation (CV value) of 25 to 45%, and the second silicon-based powder may have a particle distribution coefficient of variation (CV value) of 56 to 77%.

In addition, the silicon-based powder may be included in 80 to 94 wt % of a total weight of the mixed powder.

In addition, the nitride-based sintering aid may include any one or more of MgSiN₂ and Y₂Si₄N₆C.

In addition, the MgSiN₂ may have an average particle diameter of 0.3 to 4 μm, a particle size distribution D10 of 0.08 to 0.55 μm, a particle size distribution D50 of 0.3 to 4 μm and a particle size distribution D90 of 1.5 to 6 μm, and the Y₂Si₄N₆C may have an average particle diameter of 0.3 to 4 μm, a particle size distribution D10 of 0.08 to 0.55 μm, a particle size distribution D50 of 0.3 to 4 μm and a particle size distribution D90 of 1.5 to 6 μm.

In addition, among a total content of the nitride-based sintering aid, a content of MgSiN₂ may be the smallest, and among the nitride-based sintering aid, a particle distribution coefficient of variation (CV value) of MgSiN₂ may be the greatest.

In addition, the MgSiN₂ may have a particle distribution coefficient of variation (CV value) of 55 to 75%, and the Y₂Si₄N₆C may have a particle distribution coefficient of variation (CV value) of 35 to 55%.

In addition, the nitride-based sintering aid may include the MgSiN₂ and Y₂Si₄N₆C in a weight ratio of 1:1.2 to 2.6.

In addition, the present invention provides a silicon nitride substrate, in which the above-described composition for manufacturing a silicon nitride substrate is sintered.

Meanwhile, as used in the present specification, the terms “particle size distribution D10”, “particle size distribution D50” and “particle size distribution D90” respectively refer to particle diameters when the cumulative degrees are 10%, 50% and 90%, respectively, in the volume cumulative particle size distribution. Specifically, in a graph (volume-based particle size distribution) in which the particle diameter is taken on the horizontal axis and the volume cumulative frequency from a side with the smallest particle diameter is taken on the vertical axis, based on the volume cumulative value of all particles (100%), the particle diameters of particles, in which the cumulative values of volume % from the smallest particle diameter correspond to 10%, 50% and 90%, correspond to D10, D50 and D90, respectively. The volume cumulative particle size distribution may be measured by using a laser diffraction scattering particle size distribution device.

The composition for manufacturing a silicon nitride substrate according to the present invention and the silicon nitride substrate manufactured thereby have excellent sintered body density and thermal conductivity, excellent mechanical strength such as bending strength and wear resistance, and the effect of being able to express uniform physical properties.

### DETAILED DESCRIPTION

Hereinafter, embodiments of the present invention will be described in detail so that those with ordinary skill in the art to which the present invention pertains can easily practice the present invention. The present invention may be implemented in various different forms and is not limited to the embodiments described herein.

The composition for manufacturing a silicon nitride substrate according to the present invention includes a mixed powder including a silicon-based powder and a nitride-based sintering aid, and the mixed powder is implemented such that a particle distribution coefficient of variation (CV value) is 65 to 86%.

As described above, the mixed powder included in the composition for manufacturing a silicon nitride substrate of the present invention may have a particle distribution coefficient of variation (CV value) of 65 to 86%, and preferably a particle distribution coefficient of variation (CV value) of 67 to 84%. If the particle distribution coefficient of variation of the mixed powder is less than 65%, the density, thermal conductivity and mechanical strength may be reduced, and if the particle distribution coefficient of variation is more than 86%, the density, thermal conductivity and mechanical strength may be reduced.

In this case, the particle distribution coefficient of variation (CV value) may be calculated by using Calculation Formula 1 below.

Particle distribution coefficient of variation (CV value, %)=(Standard deviation of particle diameter (σ)/Average particle diameter (Dₙ))×100(%) [Calculation Formula 1]

In addition, the mixed powder may have an average particle diameter of 0.5 to 4 μm, and preferably, the average particle diameter may be 1 to 3.5 μm. If the average particle diameter of the mixed powder is less than 0.5 μm, the density, thermal conductivity and mechanical strength may be reduced, and if the average particle diameter is more than 4 μm, the density, thermal conductivity and mechanical strength may be reduced.

In addition, the ratio of a particle size distribution D10 (μm) and a particle size distribution D50 (μm) of the mixed powder may be 1:1.8 to 18.5, and preferably, the ratio of a particle size distribution D10 (μm) and a particle size distribution D50 (μm) may be 1:2.35 to 13. If the ratio of a particle size distribution D10 (μm) and a particle size distribution D50 (μm) of the mixed powder is less than 1:1.8, the density, thermal conductivity and mechanical strength may be reduced, and if the ratio of a particle size distribution D10 (μm) and a particle size distribution D50 (μm) of the mixed powder is more than 1:18.5, the density, thermal conductivity and mechanical strength may be reduced.

In addition, the mixed powder may have a particle size distribution D10 of 0.15 to 0.55 μm, a particle size distribution D50 of 1 to 2.7 μm, and a particle size distribution D90 of 3.8 to 6.2 μm, and preferably, the mixed powder may have a particle size distribution D10 of 0.2 to 0.5 μm, a particle size distribution D50 of 1.2 to 2.5 μm, and a particle size distribution D90 of 4.0 to 6.0 μm. If the particle size distribution D10 of the mixed powder is less than 0.15 μm, the density, thermal conductivity and mechanical strength may be reduced, and if the particle size distribution D10 is more than 0.55 μm, the mechanical strength may be reduced. In addition, if the particle size distribution D50 of the mixed powder is less than 1 μm, the density, thermal conductivity and mechanical strength may be reduced, and if the particle size distribution D50 is more than 2.7 μm, the mechanical strength may be reduced. In addition, if the particle size distribution D90 of the mixed powder is less than 3.8 μm, the density, thermal conductivity and mechanical strength may be reduced, and if the particle size distribution D90 is more than 6.2 μm, the mechanical strength may be reduced.

Meanwhile, if the silicon-based powder described below accounts for most of the total weight of the mixed powder, the particle size distribution D10 of the mixed powder may be significantly lower than the particle size distribution D10 of the silicon-based powder, and if the particle size distribution D10 of the mixed powder satisfies the above range while showing this tendency, it may be more advantageous in achieving the object of the present invention.

Hereinafter, each component of the composition for manufacturing a silicon nitride substrate of the present invention will be described.

First of all, the silicon-based powder will be described.

The silicon-based powder plays a main role in the composition for manufacturing a silicon nitride substrate according to the present invention.

The silicon-based powder may be a compound in which silicon and another element are combined, and may be, for example, an oxide of silicon and/or a nitride of silicon, but it is more advantageous to achieve the object of the present invention to use a silicon-based powder.

Meanwhile, the silicon-based powder may include a first silicon-based powder and a second silicon-based powder having a smaller average particle diameter than the first silicon-based powder.

The first silicon-based powder may have an average particle diameter of 4.1 to 6.6 μm, and preferably an average particle diameter of 4.3 to 6.4 μm, and the second silicon-based powder may have an average particle diameter of 1.1 to 3.7 μm, and preferably an average particle diameter of 1.3 to 3.5 μm. If the average particle diameter of the first silicon-based powder is less than 4.1 μm, the density, thermal conductivity and mechanical strength may be reduced, and if it is more than 6.6 μm, the mechanical strength may be reduced. In addition, if the average particle diameter of the second silicon-based powder is less than 1.1 μm, the density, thermal conductivity and mechanical strength may be reduced, and if it is more than 3.7 μm, the mechanical strength may be reduced.

In addition, the first silicon-based powder may have a particle size distribution D10 of 2.2 to 3.8 μm, a particle size distribution D50 of 4.1 to 6.5 μm and a particle size distribution D90 of 6.7 to 9.1 μm, and preferably a particle size distribution D10 of 2.3 to 3.6 μm, a particle size distribution D50 of 4.3 to 6.3 μm and a particle size distribution D90 of 6.9 to 8.9 μm, and the second silicon-based powder may have a particle size distribution D10 of 0.4 to 0.95 μm, a particle size distribution D50 of 1.1 to 2.8 μm and a particle size distribution D90 of 3 to 6.6 μm, and preferably a particle size distribution D10 of 0.45 to 0.8 μm, a particle size distribution D50 of 1.3 to 2.6 μm and a particle size distribution D90 of 3.2 to 6.4 μm.

If the D10 of the first silicon-based powder is less than 2.2 μm, the density, thermal conductivity and mechanical strength may be reduced, and if the D10 is more than 3.8 μm, the mechanical strength may be reduced. In addition, if the D50 is less than 4.1 μm, the density, thermal conductivity and mechanical strength may be reduced, and if the D50 is more than 6.5 μm, the mechanical strength may be reduced. In addition, if the D90 is less than 6.7 μm, the density, thermal conductivity and mechanical strength may be reduced, and if the D90 is more than 9.1 μm, the mechanical strength may be reduced. In addition, if the D10 of the second silicon-based powder is less than 0.4 μm, the density, thermal conductivity and mechanical strength may be reduced, and if the D10 is more than 0.95 μm, the mechanical strength may be reduced. In addition, if the D50 is less than 1.1 μm, the density, thermal conductivity and mechanical strength may be reduced, and if the D50 is more than 2.8 μm, the mechanical strength may be reduced. In addition, if the D90 is less than 3 μm, the density, thermal conductivity and mechanical strength may be reduced, and if the D90 is more than 6.6 μm, the mechanical strength may be reduced.

In addition, the particle distribution coefficient of variation (CV value) of the second silicon-based powder may be greater than the particle distribution coefficient of variation (CV value) of the first silicon-based powder.

The first silicon-based powder may have a particle distribution coefficient of variation (CV value) of 25 to 45%, and preferably, a particle distribution coefficient of variation (CV value) of 26 to 44%. If the particle distribution coefficient of variation of the first silicon-based powder is less than 25%, the density, thermal conductivity and mechanical strength may be reduced, and if the particle distribution coefficient of variation is more than 45%, the density, thermal conductivity and mechanical strength may be reduced.

In addition, the second silicon-based powder may have a particle distribution coefficient of variation (CV value) of 56 to 77%, and preferably, a particle distribution coefficient of variation (CV value) of 58 to 75%. If the particle distribution coefficient of variation of the second silicon-based powder is less than 56%, the density, thermal conductivity and mechanical strength may be reduced, and if the particle distribution coefficient of variation is more than 77%, the density, thermal conductivity and mechanical strength may be reduced.

In addition, the content of the first silicon-based powder may be greater than the content of the second silicon-based powder, and preferably, the silicon-based powder may include the first silicon-based powder and the second silicon-based powder in a weight ratio of 1:0.4 to 0.7, and more preferably, the first silicon-based powder and the second silicon-based powder in a weight ratio of 1:0.43 to 0.65. If the weight ratio of the first silicon-based powder and the second silicon-based powder is less than 1:0.4, the mechanical strength may be reduced, and if the weight ratio of the first silicon-based powder and the second silicon-based powder is more than 1:0.7 or the content of the first silicon-based powder is less than the content of the second silicon-based powder, the density, thermal conductivity and mechanical strength may be reduced.

Meanwhile, the silicon-based powder may be included at 80 to 94 wt % of the total weight of the mixed powder, and preferably 82 to 92 wt %. If the silicon-based powder is less than 80 wt % of the total weight of the mixed powder, thermal conductivity may be reduced, and if it is more than 94 wt %, the density, thermal conductivity and mechanical strength may be reduced.

Next, the nitride-based sintering aid will be described.

The nitride-based sintering aid has the function of improving density, thermal conductivity and mechanical strength, and any nitride-based sintering aid that can be commonly used in the art may be used without limitation, and preferably, it may include any one or more of MgSiN₂ and Y₂Si₄N₆C.

In this case, the MgSiN₂ may have an average particle diameter of 0.3 to 4 μm, a particle size distribution D10 of 0.08 to 0.55 μm, a particle size distribution D50 of 0.3 to 4 μm and a particle size distribution D90 of 1.5 to 6 μm, and preferably an average particle diameter of 0.5 to 3 μm, a particle size distribution D10 of 0.1 to 0.5 μm, a particle size distribution D50 of 0.5 to 3 μm and a particle size distribution D90 of 1.5 to 5 μm. If the average particle diameter of the MgSiN₂ is less than 0.3 μm, it is difficult to exhibit uniform physical properties, and if the average particle diameter is more than 0.4 μm, the density, thermal conductivity and mechanical strength may be reduced. In addition, if the particle size distribution D10 of the MgSiN₂ is less than 0.08 μm, it is difficult to uniformly express physical properties, and if it is more than 0.55 μm, the density, thermal conductivity and mechanical strength may be reduced. If the particle size distribution D50 of the MgSiN₂ is less than 0.3 μm, it may be difficult to uniformly express physical properties, and if it is more than 4 μm, the density, thermal conductivity and mechanical strength may be reduced. If the particle size distribution D90 of the MgSiN₂ is less than 1.5 μm, it is difficult to uniformly express physical properties, and if it is more than 6 μm, the density, thermal conductivity and mechanical strength may be reduced.

In addition, the Y₂Si₄N₆C may have an average particle diameter of 0.3 to 4 μm, a particle size distribution D10 of 0.08 to 0.55 μm, a particle size distribution D50 of 0.3 to 4 μm and a particle size distribution D90 of 1.5 to 6 μm, and preferably an average particle diameter of 0.5 to 3 μm, a particle size distribution D10 of 0.1 to 0.5 μm, a particle size distribution D50 of 0.5 to 3 μm and a particle size distribution D90 of 1.5 to 5 μm. If the average particle diameter of the Y₂Si₄N₆C is less than 0.3 μm, it may be difficult to uniformly express physical properties, and if the average particle diameter is more than 4 μm, the density, thermal conductivity and mechanical strength may be reduced. In addition, if the particle size distribution D10 of the Y₂Si₄N₆C is less than 0.08 μm, it may be difficult to uniformly express physical properties, and if it is more than 0.55 μm, the density, thermal conductivity and mechanical strength may be reduced. If the particle size distribution D50 of the Y₂Si₄N₆C is less than 0.3 μm, it may be difficult to uniformly express physical properties, and if it is more than 4 μm, the density, thermal conductivity and mechanical strength may be reduced. If the particle size distribution D90 of the Y₂Si₄N₆C is less than 1.5 μm, it may be difficult to uniformly express physical properties, and if it is more than 6 μm, the density, thermal conductivity and mechanical strength may be reduced.

Meanwhile, the content of MgSiN₂ among the total content of the nitride-based sintering aid may be the lowest, and preferably, the nitride-based sintering aid may include the MgSiN₂ and Y₂Si₄N₆C in a weight ratio of 1:1.2 to 2.6, and more preferably, the nitride-based sintering aid may include a first sintering aid and a second sintering aid in a weight ratio of 1:1.3 to 2.5. If the content of MgO among the total content of the nitride-based sintering aid is not the lowest, or the weight ratio of MgSiN₂ and Y₂Si₄N₆C is less than 1:1.2, it may be difficult to uniformly express physical properties, and if the weight ratio is more than 1:2.6, the density, thermal conductivity and mechanical strength may be reduced.

In addition, the particle distribution coefficient of variation (CV value) of the nitride-based sintering aid may be greater than the particle distribution coefficient of variation (CV value) of the silicon nitride-based powder described above. If the particle distribution coefficient of variation of the nitride-based sintering aid is smaller than the particle distribution coefficient of variation of the silicon nitride-based powder, it may be difficult to exhibit uniform physical properties, and the density, thermal conductivity and mechanical strength may be reduced.

In addition, the MgSiN₂ may have a particle distribution coefficient of variation (CV value) of 55 to 75%, and preferably 56 to 74%, and the Y₂Si₄N₆C may have a particle distribution coefficient of variation (CV value) of 35 to 55%, and preferably 36 to 54%.

If the particle distribution coefficient of variation of the MgSiN₂ is less than 55%, it may be difficult to uniformly express the physical properties, and the density, thermal conductivity and mechanical strength may be reduced. If it is more than 75%, it may be difficult to uniformly express the physical properties, and the density, thermal conductivity and mechanical strength may be reduced. If the particle distribution coefficient of variation of the Y₂Si₄N₆C is less than 35%, it may be difficult to uniformly express the physical properties, and the density, thermal conductivity and mechanical strength may be reduced. If it is more than 55%, it may be difficult to uniformly express the physical properties, and the density, thermal conductivity and mechanical strength may be reduced.

Meanwhile, the present invention provides a silicon nitride substrate obtained by nitriding and sintering the composition for manufacturing a silicon nitride substrate described above.

In this case, the order of nitriding and sintering of the composition is not limited, and nitriding may be performed first and then sintering may be performed, or sintering may be performed first and then nitriding may be performed. Accordingly, the present invention does not specifically limit the same.

In addition, since known methods may be used for the specific methods and conditions of the nitriding and sintering, the present invention does not specifically limit the same.

The composition for manufacturing a silicon nitride substrate according to the present invention and the silicon nitride substrate manufactured thereby have excellent sintered body density and thermal conductivity, excellent mechanical strength such as bending strength and wear resistance, and the effect of being able to express uniform physical properties.

### MODES OF THE INVENTION

The present invention will be described more specifically through the following examples, but the following examples do not limit the scope of the present invention, and should be interpreted as helping to understand the present invention.

### Example 1

First of all, 87 wt % of a silicon-based powder including a first silicon-based powder having an average particle diameter of 5.4 μm, a particle size distribution D10 of 3 μm, a D50 of 5.3 μm, a D90 of 7.9 μm and a particle distribution coefficient of variation (CV value) of 35%, and a second silicon-based powder having an average particle diameter of 2.4 μm, a particle size distribution D10 of 0.68 μm, a D50 of 2.0 μm, a D90 of 4.8 μm and a particle distribution coefficient of variation (CV value) of 66.6% in a weight ratio of 1:0.54, and 13 wt % of a nitride-based sintering aid including MgSiN₂ having an average particle diameter of 1.7 μm, a particle size distribution D10 of 0.23 μm, a D50 of 1.6 μm, a D90 of 4.3 μm and a particle distribution coefficient of variation (CV value) of 65% and Y₂Si₄N₆C having an average particle size of 1.8 μm, a particle size distribution D10 of 0.38 μm, a D50 of 1.74 μm, a D90 of 3.1 μm and a particle distribution coefficient of variation (CV value) of 45% in a weight ratio of 1:1.89 were mixed by using a premixer, and a basket mill was used to prepare a mixed powder slurry having an average particle diameter of 2.3 μm, a particle size distribution D10 of 0.36 μm, a D50 of 1.9 μm, a D90 of 5 μm and a particle distribution coefficient of variation (CV value) of 75.5%.

Then, 80 parts by weight of a solvent and 1 part by weight of a dispersant were mixed and dispersed in a first mixer with 100 parts by weight of the mixed powder, and 10 parts by weight of organic binder polyvinyl butyral (PVB) and 5 parts by weight of dioctyl phthalate (DOP) were secondarily mixed to prepare a casting slurry. The prepared slurry was used to produce a silicon green sheet having a thickness of 250 μm by using a doctor blade method. The produced green sheet was cut while taking into account the sintering shrinkage rate, and boron nitride (BN) was coated on both surfaces of the sheet to prevent reaction between the sheets during sintering. Several completed sheets with BN coating were stacked, and BBO (binder burn out), which is an organic binder removal operation, was performed at 900° C. in a reducing gas atmosphere to prevent the silicon from decomposing. The sheet on which BBO was completed was loaded into a BN box to control the reducing atmosphere and reactivity with carbon, and a nitriding process was performed at 1,400° C. for 2 hours and sintering was performed at 1,900° C. for 6 hours by using gas pressure sintering (GPS) to manufacture a silicon nitride substrate.

### Examples 2 to 8 and Comparative Examples 1 to 2

The same process as Example 1 was performed to manufacture silicon nitride substrates, except that the average particle diameter of the mixed powder, the coefficient of variation of the particle distribution, the ratio of the particle size distribution D10 and D50, the particle size distribution D10, D50, D90, the content of each of the first silicon-based powder and the second silicon-based powder, and the average particle diameter were changed to manufacture the silicon nitride substrates as shown in Tables 1 and 2 below.

### Experimental Example 1

For each silicon nitride substrate manufactured according to Examples 1 to 8 and Comparative Examples 1 to 2, the following physical properties were evaluated, and the results are shown in Tables 1 to 2.

### 1. Evaluation of Density (Compactness)

For each silicon nitride substrate manufactured according to Examples 1 to 8 and Comparative Examples 1 to 2, the density of the substrate was measured by using the Archidemes method.

### 2. Evaluation of Thermal Conductivity

For each silicon nitride substrate manufactured according to Examples 1 to 8 and Comparative Examples 1 to 2, in order to measure thermal conductivity by using the international standard ASTM E1461 (standard Test Method for Thermal Diffusivity by the laser Flash Method), a specimen with a thickness of approximately 500 μm was manufactured with a size of 10 mm×10 mm in length×width, and the thermal diffusivity was measured by using a laser flash method (Laser Flash apparatus, NETZCH, Germany), and the specific heat was measured and calculated by using Calculation Formula 2 below.

Thermal conductivity (k)=α·ρ·Cp [Calculation Formula 2]

In Calculation Formula 2 above, α represents a thermal diffusivity (mm²/S), p represents a density (g/cm³), and Cp represents a heat capacity (J/(kg K)).

### 3. Evaluation of Bending Strength

For each silicon nitride substrate manufactured according to Examples 1 to 7 and Comparative Examples 1 to 2, the bending strength was measured by using the international standard ISO 14704 (Fine ceramics (advanced ceramics, advanced technical ceramics)—test method for flexural strength of monolithic ceramics at room temperature) method, and the specimen was supported at two support points 30 mm apart by using a universal material testing machine, and a load was applied at the midpoint by using a crosshead that moved at a speed of 1 mm per minute. When the maximum load at which the specimen was destroyed was measured, the bending strength was calculated by Calculation Formula 3 below.

Bending strength (σ)=3×P×L/2×w×t² [Calculation Formula 3]

In Calculation Formula 3 above, P represents a maximum load, L represents the length of a specimen, w represents the width of a specimen, and t represents the thickness of a specimen.

TABLE 1

| | | Example | Example | Example | Example | Example |
|---|---|---|---|---|---|---|
| Classification | | 1 | 2 | 3 | 4 | 5 |
| Mixed | Average particle diameter | 2.3 | 2.3 | 2.2 | 0.42 | 4.3 |
| powder | (μm) | | | | | |
| | Particle distribution coefficient | 75.5 | 67 | 84 | 85.3 | 76.1 |
| | of variation (%) | | | | | |
| | Particle size distribution D10 | 0.36 | 0.48 | 0.21 | 0.23 | 0.52 |
| | (μm) | | | | | |
| | Particle size distribution D50 | 1.9 | 1.89 | 1.92 | 0.4 | 3.5 |
| | (μm) | | | | | |
| | Particle size distribution D90 | 5 | 4.1 | 5.9 | 3.9 | 6.1 |
| | (μm) | | | | | |
| | Ratio of particle size | 1:5.28 | 1:3.94 | 1:9.14 | 1:1.74 | 1:6.73 |
| | distribution D10 and D50 | | | | | |
| Silicon- | Weight ratio of first and | 1:0.54 | 1:0.54 | 1:0.54 | 1:0.68 | 1:0.54 |
| based | second silicon-based powders | | | | | |
| powder | Average particle diameter of | 5.4 | 5.4 | 5.4 | 3.2 | 5.4 |
| | first silicon-based powder | | | | | |
| | (μm) | | | | | |
| | Average particle diameter of | 2.4 | 2.4 | 2.4 | 0.3 | 2.4 |
| | second silicon-based powder | | | | | |
| | (μm) | | | | | |

| | | | | | |
|---|---|---|---|---|---|
| Evaluation of density (g/cm³) | 3.27 | 3.27 | 3.25 | 3.06 | 3.06 |
| Evaluation of thermal conductivity | 94 | 92 | 92 | 72 | 71 |
| (W/mK) | | | | | |
| Evaluation of bending strength (MPa) | 843 | 836 | 834 | 648 | 655 |

TABLE 2

| | | Example | Example | Example | Comparative | Comparative |
|---|---|---|---|---|---|---|
| Classification | | 6 | 7 | 8 | Example 1 | Example 2 |
| Mixed | Average particle diameter | 3.4 | 2.8 | 1.8 | 2.3 | 2.4 |
| powder | (μm) | | | | | |
| | Particle distribution coefficient | 72.6 | 71.7 | 80.2 | 62 | 89 |
| | of variation (%) | | | | | |
| | Particle size distribution D10 | 0.48 | 0.42 | 0.3 | 0.62 | 0.1 |
| | (μm) | | | | | |
| | Particle size distribution D50 | 2.3 | 2.1 | 1.3 | 2.0 | 1.9 |
| | (μm) | | | | | |
| | Particle size distribution D90 | 5.8 | 5.4 | 4.2 | 3.6 | 6.4 |
| | (μm) | | | | | |
| | Ratio of particle size | 1:4.79 | 1:5 | 1:4.33 | 1:3.23 | 1:19 |
| | distribution D10 and D50 | | | | | |
| Silicon- | Weight ratio of first and | 1:0.54 | 1:0.54 | 1:1.03 | 1:0.54 | 1:0.54 |
| based | second silicon-based powders | | | | | |
| powder | Average particle diameter of | 6.8 | 5.4 | 5.4 | 5.4 | 5.4 |
| | first silicon-based powder | | | | | |
| | (μm) | | | | | |
| | Average particle diameter of | 2.4 | 3.9 | 2.4 | 2.4 | 2.4 |
| | second silicon-based powder | | | | | |
| | (μm) | | | | | |

| | | | | |
|---|---|---|---|---|
| Evaluation of density (g/cm³) | 3.27 | 3.01 | 3.06 | 2.98 |
| Evaluation of thermal conductivity | 94 | 78 | 79 | 79 |
| (W/mK) | | | | |
| Evaluation of bending strength (MPa) | 689 | 683 | 688 | 684 |

As can be seen from Tables 1 to 2 above, it can be confirmed that Examples 1 to 3, which satisfied all of the average particle diameter, particle distribution coefficient of variation, the ratio of particle size distribution D10 and D50, particle size distribution D10, D50, D90, the contents of each of the first silicon-based powder and the second silicon-based powder and the average particle diameter of the mixed powder according to the present invention, could simultaneously achieve significantly superior effects of density, thermal conductivity and mechanical strength, compared to Examples 4 to 9 and Comparative Examples 1 to 2, which did not satisfy any one of the above.

### Examples 9 to 16 and Comparative Example 3

The same process as Example 1 was performed to manufacture silicon nitride substrates as shown in Tables 3 to 5 below, except that the weight ratio of the first silicon-based powder and the second silicon-based powder, the average particle diameter, the particle distribution coefficient of variation, the particle size distribution D10, D50 and D90, the average particle diameter of the mixed powder, the particle distribution coefficient of variation, and the ratio of particle size distribution D10 and D50 were changed.

### Experimental Example 2

The density, thermal conductivity and bending strength of each silicon nitride substrate according to Examples 1, 5 to 16 and Comparative Examples 2 to 3 were evaluated in the same manner as in Experimental Example 1 above, and the results are shown in Tables 3 to 5 below.

TABLE 3

| | | Example | Example | Example | Example | Example |
|---|---|---|---|---|---|---|
| Classification | | 1 | 5 | 6 | 7 | 8 |
| Silicon- | Weight ratio of first and | 1:0.54 | 1:0.54 | 1:0.54 | 1:0.54 | 1:1.03 |
| based | second silicon-based powders | | | | | |
| powder | Average particle diameter of | 5.4 | 5.4 | 6.8 | 5.4 | 5.4 |
| | first silicon-based powder | | | | | |
| | (μm) | | | | | |
| | Particle distribution coefficient | 35 | 35 | 32.2 | 35 | 35 |
| | of variation of first silicon- | | | | | |
| | based powder (%) | | | | | |
| | Particle size distribution D10 | 3 | 3 | 3.7 | 3 | 3 |
| | of first silicon-based powder | | | | | |
| | (μm) | | | | | |
| | Particle size distribution D50 | 5.3 | 5.3 | 6.7 | 5.3 | 5.3 |
| | of first silicon-based powder | | | | | |
| | (μm) | | | | | |
| | Particle size distribution D90 | 7.9 | 7.9 | 9.0 | 7.9 | 7.9 |
| | of first silicon-based powder | | | | | |
| | (μm) | | | | | |
| | Average particle diameter of | 2.4 | 2.4 | 2.4 | 3.9 | 2.4 |
| | second silicon-based powder | | | | | |
| | (μm) | | | | | |
| | Particle distribution coefficient | 66.6 | 66.6 | 66.6 | 68.2 | 66.6 |
| | of variation of second silicon- | | | | | |
| | based powder (%) | | | | | |
| | Particle size distribution D10 | 0.68 | 0.68 | 0.68 | 0.9 | 0.68 |
| | of second silicon-based | | | | | |
| | powder (μm) | | | | | |
| | Particle size distribution D50 | 2.0 | 2.0 | 2.0 | 3.2 | 2.0 |
| | of second silicon-based | | | | | |
| | powder (μm) | | | | | |
| | Particle size distribution D90 | 4.8 | 4.8 | 4.8 | 6.4 | 4.8 |
| | of second silicon-based | | | | | |
| | powder (μm) | | | | | |
| Mixed | Average particle diameter | 2.3 | 4.3 | 3.4 | 2.8 | 1.8 |
| powder | (μm) | | | | | |
| | Particle distribution coefficient | 75.5 | 76.1 | 72.6 | 71.7 | 80.2 |
| | of variation (%) | | | | | |
| | Particle size distribution D10 | 0.36 | 0.52 | 0.48 | 0.42 | 0.3 |
| | (μm) | | | | | |
| | Particle size distribution D50 | 1.9 | 3.5 | 2.3 | 2.1 | 1.3 |
| | (μm) | | | | | |
| | Ratio of particle size | 1:5.28 | 1:6.73 | 1:4.79 | 1:5 | 1:4.33 |
| | distribution D10 and D50 | | | | | |

| | | | | | |
|---|---|---|---|---|---|
| Evaluation of density (g/cm³) | 3.27 | 3.06 | 3.26 | 3.27 | 3.01 |
| Evaluation of thermal conductivity | 94 | 71 | 93 | 94 | 78 |
| (W/mK) | | | | | |
| Evaluation of bending strength (MPa) | 843 | 655 | 670 | 689 | 683 |

TABLE 4

| | | Example | Example | Example | Example | Example |
|---|---|---|---|---|---|---|
| Classification | | 9 | 10 | 11 | 12 | 13 |
| Silicon- | Weight ratio of first and | 1:0.54 | 1:0.54 | 1:0.2 | 1:0.9 | 1:0.54 |
| based | second silicon-based powders | | | | | |
| powder | Average particle diameter of | 5.4 | 5.4 | 5.4 | 5.4 | 5.4 |
| | first silicon-based powder | | | | | |
| | (μm) | | | | | |
| | Particle distribution coefficient | 52 | 35 | 35 | 35 | 21 |
| | of variation of first silicon- | | | | | |
| | based powder (%) | | | | | |
| | Particle size distribution D10 | 1.8 | 3 | 3 | 3 | 4.1 |
| | of first silicon-based powder | | | | | |
| | (μm) | | | | | |
| | Particle size distribution D50 | 5.3 | 5.3 | 5.3 | 5.3 | 5.3 |
| | of first silicon-based powder | | | | | |
| | (μm) | | | | | |
| | Particle size distribution D90 | 9.4 | 7.9 | 7.9 | 7.9 | 6.4 |
| | of first silicon-based powder | | | | | |
| | (μm) | | | | | |
| | Average particle diameter of | 2.4 | 0.9 | 2.4 | 2.4 | 2.4 |
| | second silicon-based powder | | | | | |
| | (μm) | | | | | |
| | Particle distribution coefficient | 49 | 62.0 | 66.6 | 66.6 | 66.6 |
| | of variation of second silicon- | | | | | |
| | based powder (%) | | | | | |
| | Particle size distribution D10 | 1.02 | 0.44 | 0.68 | 0.68 | 0.68 |
| | of second silicon-based | | | | | |
| | powder (μm) | | | | | |
| | Particle size distribution D50 | 2.0 | 0.88 | 2.0 | 2.0 | 2.0 |
| | of second silicon-based | | | | | |
| | powder (μm) | | | | | |
| | Particle size distribution D90 | 2.95 | 3.1 | 4.8 | 4.8 | 4.8 |
| | of second silicon-based | | | | | |
| | powder (μm) | | | | | |
| Mixed | Average particle diameter | 2.33 | 2.07 | 3.62 | 1.93 | 2.27 |
| powder | (μm) | | | | | |
| | Particle distribution coefficient | 77.6 | 75.2 | 77.6 | 74.1 | 69 |
| | of variation (%) | | | | | |
| | Particle size distribution D10 | 0.34 | 0.32 | 0.53 | 0.28 | 0.49 |
| | (μm) | | | | | |
| | Particle size distribution D50 | 1.95 | 1.8 | 2.56 | 1.65 | 1.82 |
| | (μm) | | | | | |
| | Ratio of particle size | 1:5.74 | 1:5.63 | 1:4.83 | 1:5.89 | 1:3.71 |
| | distribution D10 and D50 | | | | | |

| | | | | |
|---|---|---|---|---|
| Evaluation of density (g/cm³) | 3.17 | 3.18 | 3.07 | 3.08 |
| Evaluation of thermal conductivity | 77 | 91 | 76 | 77 |
| (W/mK) | | | | |
| Evaluation of bending strength (MPa) | 697 | 660 | 681 | 690 |

TABLE 5

| | | | | | Comparative | Comparative |
|---|---|---|---|---|---|---|
| Classification | | Example 14 | Example 15 | Example 16 | Example 2 | Example 3 |
| Silicon- | Weight ratio of first and | 1:0.54 | 1:0.64 | 1:0.64 | 1:0.54 | 1:0.54 |
| based | second silicon-based powders | | | | | |
| powder | Average particle diameter of | 5.4 | 4.2 | 2.4 | 5.4 | 3.7 |
| | first silicon-based powder | | | | | |
| | (μm) | | | | | |
| | Particle distribution coefficient | 35 | 35.1 | 66.6 | 35 | 30.6 |
| | of variation of first silicon- | | | | | |
| | based powder (%) | | | | | |
| | Particle size distribution D10 | 3 | 2.3 | 0.68 | 3 | 2.3 |
| | of first silicon-based powder | | | | | |
| | (μm) | | | | | |
| | Particle size distribution D50 | 5.3 | 4.2 | 2.0 | 5.3 | 3.5 |
| | of first silicon-based powder | | | | | |
| | (μm) | | | | | |
| | Particle size distribution D90 | 7.9 | 6.8 | 4.8 | 7.9 | 6.9 |
| | of first silicon-based powder | | | | | |
| | (μm) | | | | | |
| | Average particle diameter of | 2.4 | 1.2 | 5.4 | 2.4 | 1.2 |
| | second silicon-based powder | | | | | |
| | (μm) | | | | | |
| | Particle distribution coefficient | 80.1 | 66.4 | 35 | 66.6 | 61.5 |
| | of variation of second silicon- | | | | | |
| | based powder (%) | | | | | |
| | Particle size distribution D10 | 0.27 | 0.5 | 3 | 0.68 | 0.46 |
| | of second silicon-based | | | | | |
| | powder (μm) | | | | | |
| | Particle size distribution D50 | 2.0 | 1.2 | 5.3 | 2.0 | 1.13 |
| | of second silicon-based | | | | | |
| | powder (μm) | | | | | |
| | Particle size distribution D90 | 6.9 | 3.1 | 7.9 | 4.8 | 3.09 |
| | of second silicon-based | | | | | |
| | powder (μm) | | | | | |
| Mixed | Average particle diameter | 2.28 | 0.45 | 1.43 | 2.4 | 1.31 |
| powder | (μm) | | | | | |
| | Particle distribution coefficient | 76.2 | 73.3 | 68.7 | 89 | 54.2 |
| | of variation (%) | | | | | |
| | Particle size distribution D10 | 0.35 | 0.1 | 0.18 | 0.1 | 0.58 |
| | (μm) | | | | | |
| | Particle size distribution D50 | 1.82 | 0.44 | 1.43 | 1.9 | 0.9 |
| | (μm) | | | | | |
| | Ratio of particle size | 1:5.2 | 1:4.4 | 1:7.94 | 1:19 | 1:1.55 |
| | distribution D10 and D50 | | | | | |

| | | | | |
|---|---|---|---|---|
| Evaluation of density (g/cm³) | 3.06 | 2.89 | 2.98 | 3.18 |
| Evaluation of thermal conductivity | 73 | 73 | 79 | 77 |
| (W/mK) | | | | |
| Evaluation of bending strength (MPa) | 652 | 658 | 684 | 694 |

As can be seen from Tables 3 to 5 above, it can be confirmed that Example 1, which satisfied all of the weight ratio of the first silicon-based powder and the second silicon-based powder according to the present invention, the average particle diameter, the particle distribution coefficient of variation, the particle size distribution D10, D50 and D90, the average particle diameter of the mixed powder, the particle distribution coefficient of variation, and the ratio of particle size distribution D10 and D50, could simultaneously achieve significantly superior effects of density, thermal conductivity and mechanical strength, compared to Examples 5 to 16 and Comparative Examples 2 to 3, which did not satisfy any one of the above.

Although one embodiment of the present invention has been described above, the spirit of the present invention is not limited to the embodiment presented in the present specification, and those skilled in the art who understand the idea of the present invention will be able to easily propose other embodiments by modifying, changing, deleting or adding components within the scope of the same spirit, but this will also be considered to fall within the spirit of the present invention.

1. A composition for manufacturing a silicon nitride substrate, comprising a mixed powder comprising a silicon-based powder and a nitride-based sintering aid, wherein the mixed powder has a particle distribution coefficient of variation (CV value) of 60 to 86%.

2. The composition of claim 1, wherein the mixed powder has an average particle diameter of 0.5 to 4 μm.

3. The composition of claim 1, wherein the mixed powder has a ratio of a particle size distribution D10 (μm) and a particle size distribution D50 (μm) of 1:1.8 to 18.5.

4. The composition of claim 1, wherein the mixed powder has a particle size distribution D10 of 0.15 to 0.55 μm, a particle size distribution D50 of 1 to 2.7 μm, and a particle size distribution D90 of 3.8 to 6.2 μm.

5. The composition of claim 1, wherein the silicon-based powder comprises a first silicon-based powder and a second silicon-based powder having a smaller average particle diameter than the first silicon-based powder.

6. The composition of claim 5, wherein a content of the first silicon-based powder is greater than a content of the second silicon-based powder.

7. The composition of claim 5, wherein a particle distribution coefficient of variation (CV value) of the second silicon-based powder is greater than a particle distribution coefficient of variation (CV value) of the first silicon-based powder.

8. The composition of claim 5, wherein the first silicon-based powder has an average particle diameter of 4.1 to 6.6 μm, and
wherein the second silicon-based powder has an average particle diameter of 1.1 to 3.7 μm.

9. The composition of claim 5, wherein the silicon-based powder comprises the first silicon-based powder and the second silicon-based powder in a weight ratio of 1:0.4 to 0.7.

10. The composition of claim 5, wherein the first silicon-based powder has a particle size distribution D10 of 2.2 to 3.8 μm, a particle size distribution D50 of 4.1 to 6.5 μm and a particle size distribution D90 of 6.7 to 9.1 μm, and
wherein the second silicon-based powder has a particle size distribution D10 of 0.4 to 0.95 μm, a particle size distribution D50 of 1.1 to 2.8 μm and a particle size distribution D90 of 3 to 6.6 μm.

11. The composition of claim 5, wherein the first silicon-based powder has a particle distribution coefficient of variation (CV value) of 25 to 45%, and
wherein the second silicon-based powder has a particle distribution coefficient of variation (CV value) of 56 to 77%.

12. The composition of claim 1, wherein the silicon-based powder is comprised in 80 to 94 wt % of a total weight of the mixed powder.

13. The composition of claim 1, wherein the nitride-based sintering aid comprises any one or more of MgSiN₂ and Y₂Si₄N₆C.

14. The composition of claim 13, wherein the MgSiN₂ has an average particle diameter of 0.3 to 4 μm, a particle size distribution D10 of 0.08 to 0.55 μm, a particle size distribution D50 of 0.3 to 4 μm and a particle size distribution D90 of 1.5 to 6 μm, and
wherein the Y₂Si₄N₆C has an average particle diameter of 0.3 to 4 μm, a particle size distribution D10 of 0.08 to 0.55 μm, a particle size distribution D50 of 0.3 to 4 μm and a particle size distribution D90 of 1.5 to 6 μm.

15. The composition of claim 13, wherein among a total content of the nitride-based sintering aid, a content of MgSiN₂ is the smallest, and
wherein among the nitride-based sintering aid, a particle distribution coefficient of variation (CV value) of MgSiN₂ is the greatest.

16. The composition of claim 13, wherein the MgSiN₂ has a particle distribution coefficient of variation (CV value) of 55 to 75%, and
wherein the Y₂Si₄N₆C has a particle distribution coefficient of variation (CV value) of 35 to 55%.

17. The composition of claim 13, wherein the nitride-based sintering aid comprises the MgSiN₂ and Y₂Si₄N₆C in a weight ratio of 1:1.2 to 2.6.

18. A silicon nitride substrate, in which the composition for manufacturing a silicon nitride substrate according to claim 1 is sintered.
